(19) United States
(12) Patent Application Publication
(10) Pub. No.: US 2007/0205968 A1
(43) Pub. Date: Sep. 6, 2007

(54) Organic light-emitting diode display, organic light-emitting diode panel and driving device thereof

(76) Inventor: Pei-Ming Chen, Taoyuan (TW)

Correspondence Address: J.C. Patents, Inc., 4 Venture, Suite 250, Irvine, CA, 92618, US

(21) Appl. No.: 11/455,129

(22) Filed: Jun. 15, 2006

(30) Foreign Application Priority Data
Mar. 3, 2006 (TW) 95107165

(51) Int. Cl. G09G 3/30

(52) U.S. Cl. 345/76

(57) ABSTRACT

An OLED display, an OLED panel and a driving device are disclosed. Wherein, the OLED display includes the OLED and the driving device. The OLED panel has a plurality of display pixels, every display pixel includes a plurality of sub-pixels, and each of the sub-pixels respectively corresponds to a different color. The driving device includes a plurality of current mirrors for correspondingly receiving one of a plurality of data currents and for generating driving currents sent to the corresponding sub-pixels, respectively. Each the current mirror includes a plurality of transistors and generates a different driving current to drive the corresponding sub-pixels according to the ratios between the channel widths and channel lengths of the transistors in the current mirror.

### CROSS-REFERENCE TO RELATED APPLICATION

This application claims the priority benefit of Taiwan application serial no. 95107165, filed on Mar. 3, 2006. All disclosure of the Taiwan application is incorporated herein by reference.

### BACKGROUND OF THE INVENTION

1. Field of Invention

The present invention relates to a driving device, and particularly to a driving device of an organic light-emitting diode panel (OLED panel).

2. Description of the Related Art

FIG. 1 is a characteristic curve chart of luminance vs. current for different color organic light-emitting diodes (OLEDs). Referring to FIG. 1, it can be seen that for driving currents with the same amount, the luminance produced by red, green and blue OLED pixels is different from each other, However, such a result does not meet the real requirement of an OLED display. In fact, different OLED displays require different luminance ratios among the red OLED, the green OLED and the blue OLED. Therefore, how to make the luminance ratios among the red OLED, the green OLED and the blue OLED expected by means of adjusting the driving signal or adjusting the process and the characteristics of components is an important project for designing an OLED display.

FIG. 2 is a diagram of a conventional OLED panel. Referring to FIG. 2, an OLED panel 200 has a plurality of sub-pixel sets, (SP_{R1}, SP_{G1}, SP_{B1}), (SP_{R1,} SP_{G1}, SP_{B1}) and so on, wherein SP_{R}, SP_{G} and SP_{B} denote red sub-pixel, green sub-pixel and blue sub-pixel, respectively. For a sub-pixel, the relation between the luminance L and the current I_{data} thereof can be expressed in equation (1):

L=k′×I_{data}×E (1)

where k′ is a constant and E represents a current efficiency of a sub-pixel.

For the red sub-pixel SP_{R}, the green sub-pixel SP_{G} and the blue sub-pixel SP_{B} in FIG. 2, all the currents I_{data} thereof are equal to each other, thus, the luminance ratios among the red OLED, the green OLED and the blue OLED can be expressed by L_{R}:L_{G}:L_{B}=E_{R}:E_{G}:E_{B}. That is, if the currents flowing through the sub-pixels are the same, the luminance ratios among the red OLED, the green OLED and the blue OLED are equal to the current efficiency ratios among the red OLED, the green OLED and the blue OLED. Nevertheless, such luminance ratios may not meet the requirement of an OLED display where the luminance ratios among the red OLED, the green OLED and the blue OLED must comply with the required proportion to form white light, so to achieve full colorization for an OLED display. Hence, a scheme using the same data currents corresponding to a same gray-level to drive the red sub-pixel, the green sub-pixel and the blue sub-pixel having different characteristics is not a proper design, since the luminance ratios thereof do not comply with the required proportion to form white light.

Note that the conventional OLED panel shown in FIG. 2, wherein three different sets of data currents corresponding to the gray-levels are required to individually drive the three sub-pixels, brings a quite complicate driving method to be implemented.

In addition, in the prior art, the scheme by adjusting the area ratios among the red sub-pixel, the green sub-pixel and the blue sub-pixel to change the luminance ratios among the red sub-pixel, the green sub-pixel and the blue sub-pixel and further to comply with the specification of an OLED display would increase the process burden, although the scheme enables the red sub-pixel, the green sub-pixel and the blue sub-pixel to meet the requirement of luminance ratios. In the R.O.C patent No. 558693, a novel technology to adjust the luminance of sub-pixels to obtain the expected luminance ratios is disclosed. FIG. 3 is a schematic drawing of a conventional driving circuit for an OLED pixel to reflect the spirit of the R.O.C patent No. 558693. Referring to FIG. 3, a pixel 10 includes a switch thin film transistor (TFT) 102, a capacitor 104, a driving TFT 106 and an OLED 108.

Both the above-mentioned switch TFT 102 and the driving TFT 106 have a drain, a gate and a source, and the capacitor 104 has a first terminal and a second terminal. Wherein, the drain of the switch TFT 102 is coupled to a data voltage V_{data}, the gate thereof is coupled to a scan voltage V_{scan} and the source thereof is coupled to the first terminal of the capacitor 104 and the gate of the driving TFT 106. Besides, the drain of the driving TFT 106 is coupled to a supply voltage VDD, the gate thereof is coupled to the first terminal of the capacitor 104, the source thereof is coupled to the positive electrode of the OLED 108 and the negative electrode of the OLED 108 is coupled to another supply voltage VSS.

According to the above-mentioned pixel circuit design, by adjusting the ratio between the channel width and channel length of the driving transistor 106, the currents of the sub-pixels for different colors can be controlled, so that the required luminance ratios among the red OLED, the green OLED and the blue OLED are obtained to meet the requirement for forming white light. However, such a conventional design would affect the aperture ratio of a display and fail to optimize the aperture ratio.

### SUMMARY OF THE INVENTION

The present invention provides an OLED display, an OLED panel and a driving device, wherein the OLED display includes the OLED panel and the driving device and is suitable for adjusting the luminance of the sub-pixels to produce expected colors without changing the other components and the configuration thereof.

The driving circuit of the present invention is independent from the pixel circuit, so that the aperture ratio thereof is not affected and further different currents can be used to drive the pixel circuit.

The OLED panel of the present invention has a plurality of display pixels and a driving device, wherein each display pixel includes a plurality of sub-pixels corresponding to different colors, respectively. The driving device includes a plurality of current mirrors for correspondingly receiving one of data currents, respectively, while each of the current mirrors includes a plurality of transistors. The current mirror would generate different driving currents to drive the corresponding sub-pixels according to the ratio between the channel width and channel length of the transistor therein.

In an embodiment of the present invention, the transistors of every current mirror in the above-mentioned OLED panel can be NMOS-type transistors or PMOS-type transistors. The driving device is not restricted to be disposed in the OLED panel. Therefore, in an embodiment of the present invention, the driving device can be disposed in the driving circuit thereof.

In an embodiment of the present invention, the above-mentioned driving device includes a first current mirror, a second current mirror and a third current mirror to drive red sub-pixels, green sub-pixels and blue sub-pixels. Wherein, the first current mirror includes a first transistor and a second transistor; the first source/drain terminal of the first transistor is coupled to the gate terminal thereof and receives a corresponding data current; the second source/drain terminal is coupled to a reference voltage. The first source/drain terminal of the second transistor is coupled to corresponding sub-pixels for creating the corresponding driving currents; the gate terminal and the second source/drain terminal of the second transistor are coupled to the gate terminal and the second source/drain terminal of the first transistor, respectively. Wherein, the quotient of the ratio between the channel width and channel length of the second transistor by the ratio between the channel width and channel length of the first transistor is termed as the first ratio.

On the other hand, the second current mirror includes a third transistor and a fourth transistor, wherein the first source/drain terminal of the third transistor is coupled to the gate terminal thereof and receives a corresponding data current; the second source/drain terminal is coupled to a reference voltage. The first source/drain terminal of the fourth transistor is coupled to corresponding sub-pixels for creating the corresponding driving currents; the gate terminal and the second source/drain terminal of the fourth transistor are coupled to the gate terminal and the second source/drain terminal of the third transistor, respectively. Wherein, the quotient of the ratio between the channel width and channel length of the fourth transistor by the ratio between the channel-width and channel length of the third transistor is termed as the second ratio.

In addition, the third current mirror includes a fifth transistor and a sixth transistor, wherein the first source/drain terminal of the fifth transistor is coupled to the gate terminal thereof and receives a corresponding data current; the second source/drain terminal is coupled to a reference voltage. The first source/drain terminal of the sixth transistor is coupled to corresponding sub-pixels for creating the corresponding driving currents; the gate terminal and the second source/drain terminal of the sixth transistor are coupled to the gate terminal and the second source/drain terminal of the fifth transistor, respectively. Wherein, the quotient of the ratio between the channel width and channel length of the sixth transistor by the ratio between the channel width and channel length of the fifth transistor is termed as the third ratio.

In another embodiment of the present invention, the driving device of the present invention further includes a fourth current mirror to drive white sub-pixels, wherein the fourth current mirror includes a seventh transistor and an eighth transistor. The first source/drain terminal of the seventh transistor is coupled to the gate terminal thereof and receives a corresponding data current; the second source/drain terminal is coupled to a reference voltage. The first source/drain terminal of the eighth transistor is coupled to corresponding sub-pixels for creating the corresponding driving currents; the gate terminal and the second source/drain terminal of the eighth transistor are coupled to the gate terminal and the second source/drain terminal of the seventh transistor, respectively. Wherein, the quotient of the ratio between the channel width and channel length of the eighth transistor by the ratio between the channel width and channel length of the seventh transistor is termed as the fourth ratio.

The OLED display of the present invention includes a driving circuit and an above-mentioned OLED panel and the driving circuit is used for outputting a plurality of data currents. Each of the current mirrors respectively receives one of the corresponding data currents and generates a plurality of driving currents to respectively drive the corresponding sub-pixels according to the ratio between the channel width and channel length of the transistor in the current mirror. That is, a data current is in charge of driving a plurality of sub-pixels.

In an embodiment of the present invention, the driving device of the above-mentioned OLED display includes a first current mirror, a second current mirror and a third current mirror to drive red sub-pixels, green sub-pixels and-blue sub-pixels. Wherein, the first current mirror includes a first transistor and a second transistor, the second current mirror includes a third transistor and a fourth transistor and the third current mirror includes a fifth transistor and a sixth transistor, wherein the coupling arrangement of the above-mentioned transistors is similar to or same as the one of the transistors in an OLED panel.

In further an embodiment of the present invention, the driving device of the above-mentioned OLED display and the OLED panel further includes a fourth current mirror to drive white sub-pixels, wherein the fourth current mirror includes a seventh transistor and an eighth transistor. The coupling arrangement of the seventh and eighth transistors is similar to or same as the one of the transistors in an OLED panel, and for simplicity, the details are omitted.

Since the present invention adopts current mirrors to convert the data currents, thus, it is able to adjust the luminance of sub-pixels by controlling the ratios between the channel width and channel length of the driving transistors in the current mirrors, so that the luminance ratios among the red sub-pixel, the green red sub-pixel and the blue red sub-pixel meet the requirement to form white light and to achieve the full colorization goal of an OLED display. Note that the scheme that a plurality of sub-pixels is driven by a data current makes the driving method simpler as well.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a characteristic curve chart of luminance vs. current for organic light-emitting diodes (OLEDs) with red light, green light and blue light, respectively.

FIG. 2 is a diagram of a conventional OLED panel.

FIG. 3 is a schematic drawing of a conventional driving circuit for an OLED pixel.

FIG. 4 is a diagram of an OLED display structure according to the first embodiment of the present invention.

FIG. 5 is a diagram of an OLED display structure according to the second embodiment of the present invention (where the data line is directly coupled to a driving current).

FIG. 6 is a diagram of an OLED display structure according to the third embodiment of the present invention.

FIG. 7 is a diagram of an OLED display structure according to the fourth embodiment of the present invention.

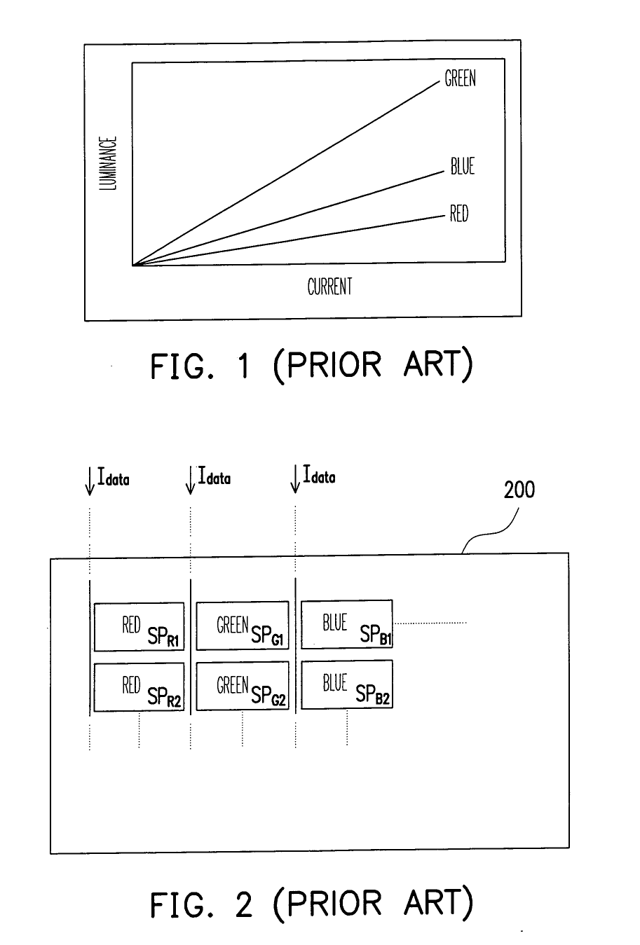

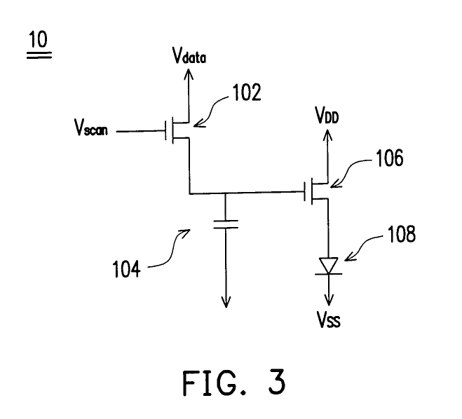

### DESCRIPTION OF THE EMBODIMENTS

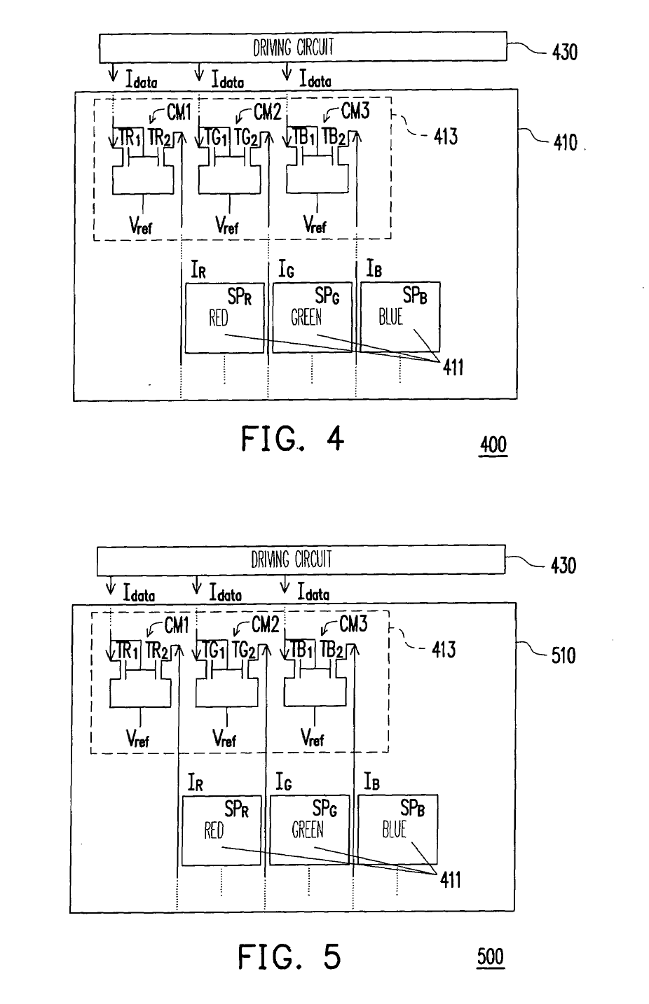

FIG. 4 is a diagram of an OLED display structure according to the first embodiment of the present invention. Referring to FIG. 4, the OLED display 400 provided by the embodiment includes an OLED panel 410 and a driving circuit 430.

The OLED panel 410 provided by the present invention has a plurality of display pixels 411 and a driving device 413 disposed in the OLED panel 410. Wherein, every display pixel 411 includes a plurality of sub-pixels, for example, a sub-pixel SP_{R}, a sub-pixel SP_{G} and a sub-pixel SP_{B}. In the embodiment, the sub-pixels SP_{R}, SP_{G} and SP_{B} correspond, but not limited to by the present invention, to red color, the green color and blue color.

The driving device 413 provided by the present invention includes a current mirror CM 1, a current mirror CM2 and a current mirror CM3 for correspondingly receiving one of the data currents I_{data} come from the driving circuit 430 and creating a driving current I_{R}, a driving current I_{G} and a driving current I_{B} sent to the corresponding sub-pixels SP_{R}, SP_{G} and SP_{B}, respectively. The current mirror CM1 includes a transistor TR₁ and a transistor TR₂, the current mirror CM2 includes a transistor TG₁ and a transistor TG₂ and the current mirror CM3 includes a transistor TB₁ and a transistor TB₂. Note that in the present invention the ratios between the channel width and channel length of the NMOS-type transistors TR₁, TR₂, TG₁, TG₂, TB₁, TB₂, in the current mirrors CM1, CM2 and CM3 are controlled to generate different driving currents I_{R}, I_{G} and I_{B} to drive the sub-pixels SP_{R}, SP_{G} and SP_{B} and accordingly to make the luminance ratios among the red sub-pixel, the green red sub-pixel and the blue red sub-pixel meet the requirement. Besides, the driving currents I_{R}, I_{G} and I_{B} are not required to be directly coupled to the sub-pixels SP_{R}, SP_{G} and SP_{B} for driving the same.

In terms of the sub-pixels SP_{R}, SP_{G} and SP_{B}, the luminance L_{R}, L_{G} and L_{B} thereof is related to the driving currents I_{R}, I_{G} and I_{B} flowing through the sub-pixels, and the relationship can be expressed by the equations (2), (3) and (4):

L_{R}=k′×I_{R}×E_{R} (2)

L_{G}=k′×I_{G}×E_{G} (3)

L_{B}=k′×I_{B}×E_{B} (4)

where k′ is a constant, and E_{R}, E_{G} and E_{B} denote current efficiencies of the sub-pixels SP_{R}, SP_{G} and SP_{B}.

From the equations, it can be seen that the luminance L_{R} of the sub-pixel SP_{R} is proportional to the driving current I_{R} and the current efficiency E_{R}. In the same way, the luminance L_{G} of the sub-pixel SP_{G} is proportional to the driving current I_{G} and the current efficiency E_{B} and the luminance L_{B} of the sub-pixel SP_{B} is proportional to the driving current I_{B} and the current efficiency E_{B}.

For the sub-pixel SP_{R}, the driving current I_{R} thereof is related to the channel width W_{R2} and the channel length L_{R2} of the NMOS-type transistor TR₂ by the equation (5):

I_{R}=k2(W_{R2}/L_{R2})(Vgs2−Vth2)² (5)

where k2 is a constant, Vgs2 and Vth2 denote the voltage of gate-source and the threshold voltage of the transistor TR₂, respectively.

On the other hand, in terms of the NMOS-type transistor TR₁, the data current I_{data} thereof is related to the channel width W_{R1} and the channel length L_{R1} of the NMOS-type transistor TR₁, by the equation (6):

I_{data}=k1(W_{R1}/L_{R1})(Vgs1−Vth1)² (6)

where k1 is a constant, Vgs1 and Vth1 denote the voltage of gate-source and the threshold voltage of the transistor TR₁, respectively.

We can use the same condition (such as material, structure and process etc.) to make the characteristics of TR1 and TR2 similar. So the k1 will equal to k2 and the Vth1 will equal to Vth2. The gate terminal of TR1 is coupled to the gate terminal of TR2 and the source terminal of TR1 is coupled to the source terminal of TR2, the Vgs 1 will equal to Vgs2.

Combining equations (5) and (6), the relationship between the driving current I_{R} and the channel widths W_{R1} and W_{R2} and the channel lengths L_{R1} and L_{R2} is derived:

I_{R}=[(W_{R2}/L_{R2})/(W_{R1}/L_{R1})]×I_{data} (7)

In the same way, the relationship between the driving current I_{G} and the channel widths W_{G1} and W_{G2} and the channel lengths L_{G1} and L_{G2} and the relationship between the driving current I_{B} and the channel widths W_{B1} and W_{B2} and the channel lengths L_{B1} and L_{B2} are derived as shown in the following equations (8) and (9):

I_{G}=[(W_{G2}/L_{G2})/(W_{G1}/L_{G1})]×I_{data} (8)

I_{B}=[(W_{B2}/L_{B2})/(W_{B1}/L_{B1})]×I_{data} (9)

The driving current I_{R} in equation (2) is substituted by equation (7), the driving current I_{R} in equation (3) is substituted by equation (8) and the driving current I_{R} in equation (4) is substituted by equation (9), respectively; thus, the corresponding luminance L_{R}, L_{G} and L_{B} of the sub-pixels SP_{R}, SP_{G} and SP_{B} are obtained by the following equations:

L_{R}=k′″×I_{R}×E_{R}=k′″×[(W_{R2}/L_{R2})/(W_{R1}/L_{R1})]×I_{data}×E_{R} (10)

L_{G}=k′″×I_{G}×E_{G}=k′″×[(W_{G2}/L_{G2})/(W_{G1}/L_{G1})]×I_{data}×E_{G} (11)

L_{B}=k′″×I_{B}×E_{B}=k′″×[(W_{B2}/L_{B2})/(W_{B1}/L_{B1})]×I_{data}×E_{B} (12)

where k′″ is a constant.

According to equations (10), (11) and (12), the luminance L_{R}, L_{G} and L_{B} of the sub-pixels SP_{R}, SP_{G} and SP_{B} can be decided in the present invention by adjusting the channel widths W_{R1}, W_{R2}, W_{B1}, W_{B2}, W_{G1} and W_{G2} and the channel lengths L_{R}, L_{G}, L_{B}, L_{R1}, L_{R2}, L_{B1}, L_{B2}, L_{G1} and L_{G2} of the NMOS-type transistors TR₁, TR₂, TG₁, TG₂, TB₁ and TB₂.

The current mirror CM1 has an NMOS-type transistor TR₁, and an NMOS-type transistor TR₂, wherein the drain terminal and the gate terminal of the NMOS-type transistor TR₁, are coupled to each other for receiving a corresponding data current I_{data}, while the source terminal thereof is coupled to a reference voltage V_{ref}. The drain terminal of the NMOS-type transistor TR₂ is coupled to the sub-pixel SP_{R} to generate a driving current I_{R} to drive the sub-pixel SP_{R}. Besides, the gate terminal and the source terminal of the transistor TR₂ are coupled to the gate terminal and the source terminal of the transistor TR₁, respectively. Wherein, the quotient of the ratio between the channel width and channel length of the transistor TR₂ by the ratio between the channel width and channel length of the transistor TR₁, (W_{R2}/L_{R2})/(W_{R1}/L_{R1}), is termed as the first ratio. As the above described, the first ratio is used for adjusting the luminance of the sub-pixel SP_{R}.

In the same way, the current mirror CM2 has also an NMOS-type transistor TG₁ and an NMOS-type transistor TG₂, wherein the drain terminal and the gate terminal of the NMOS-type transistor TG₁ are coupled to each other for receiving a corresponding data current I_{data}, while the source terminal thereof is coupled to the reference voltage V_{ref}. The drain terminal of the NMOS-type transistor TG₂ is coupled to the sub-pixel SP_{G} to generate a driving current I_{R} to drive the sub-pixel SP_{G}. Besides, the gate terminal and the source terminal of the transistor TG₂ are coupled to the gate terminal and the source terminal of the transistor TG₁, respectively. Wherein, the quotient of the ratio between the channel width and channel length of the transistor TG₂ by the ratio between the channel width and channel length of the transistor TG₁, (W_{G2}/L_{G2})/(W_{G1}/L_{G1}), is the second ratio for adjusting the luminance of the sub-pixel SP_{G}.

The current mirror CM3 has also an NMOS-type transistor TB₁, and an NMOS-type transistor TB₂, wherein the drain terminal and the gate terminal of the NMOS-type transistor TB₁, are coupled to each other for receiving a corresponding data current I_{data}, while the source terminal thereof is coupled to the reference voltage V_{ref}. The drain terminal of the NMOS-type transistor TB₂ is coupled to the sub-pixel SP_{B} to generate a driving current I_{R} to drive the sub-pixel SP_{B}. Besides, the gate terminal and the source terminal of the transistor TB₂ and the gate terminal are coupled to the source terminal of the transistor TB₁, respectively. Wherein, the quotient of the ratio between the channel width and channel length of the transistor TB₂ by the ratio between the channel width and channel length of the transistor TB₁, (W_{B2}/L_{B2})/(W_{B1}/L_{B1}), is the third ratio for adjusting the luminance of the blue sub-pixel SP_{B}.

FIG. 5 is a diagram of an OLED display structure according to the second embodiment of the present invention (where the data line is directly coupled to a driving current). Referring to FIG. 5, the OLED display 500 of the embodiment includes an OLED panel 510 and a driving circuit 430, wherein the OLED panel 510 has a plurality of display pixels 411 and a driving device 413. In the same way, the display pixel 411 includes a plurality of sub-pixels SP_{R}, SP_{G} and SP_{B}.

Similar to FIG. 4, the driving device 413 includes a current mirror CM1, a current mirror CM2 and a current mirror CM3 for correspondingly receiving one of the data currents I_{data} come from the driving circuit 430 and creating a driving current I_{R}, a driving current I_{G} and a driving current I_{B} sent to the corresponding sub-pixels SP_{R}, SP_{G} and SP_{B}, respectively. The current mirror CM1 includes a transistor TR₁, and a transistor TR₂, the current mirror CM2 includes a transistor TG₁ and a transistor TG₂ and the current mirror CM3 includes a transistor TB₁ and a transistor TB₂.

The relationships among the luminance L_{R}, L_{G} and L_{B} of the sub-pixels SP_{R}, SP_{G} and SP_{B}, the driving currents I_{R}, I_{G} and I_{B}, the channel widths W_{R1}, W_{R2}, W_{B1}, W_{B2}, W_{G1} and W_{G2} and channel lengths L_{R1}, L_{R2}, L_{B1}, L_{B2}, L_{G1}, L_{G2} of the NMOS-type transistors TR₁, TR₂, TG₁, TG₂, TB₁ and TB₂ are similar to or the same as equations (10), (11) and (12). Besides, the coupling relationships among the NMOS-type transistors TR₁, TR₂, TG₁, TG₂, TB₁ and TB₂ are the same as the ones in FIG. 4. Different from the first embodiment, the driving currents I_{R}, I_{G} and I_{B} in the embodiment directly drive the sub-pixels SP_{R}, SP_{G} and SP_{B}, that is, the driving currents I_{R}, I_{G} and I_{B} are directly coupled to the data lines for driving the sub-pixels SP_{R}, SP_{G} and SP_{B}.

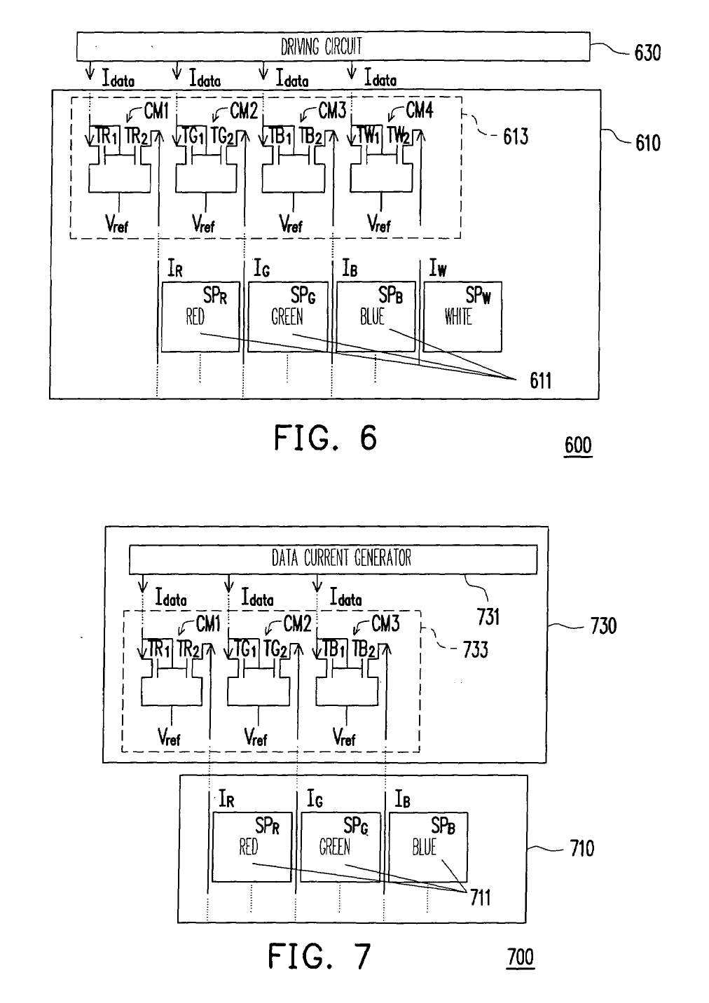

FIG. 6 is a diagram of an OLED display structure according to the third embodiment of the present invention. Referring to FIG. 6, an OLED display 600 provided by the present embodiment includes an OLED panel 610 and a driving circuit 630. Similarly, the OLED panel 610 includes a plurality of display pixels 611 and a driving device 613, too. In particular, the display pixels 611 in the embodiment includes a plurality of sub-pixels SP_{R}, SP_{G}, SP_{B} and SP_{W} respectively corresponding to red light, green light, blue light and white light.

For the most part, the structure of the driving device 613 is similar to the above-described first embodiment and second embodiment. In the embodiment, however, each of the display pixels includes four sub-pixels. Therefore, an extra current mirror CM4 is required in the driving device 613 for receiving a corresponding data current I_{data} and creating a driving current I_{W} sent to the sub-pixel SP_{W}.

The current mirror CM4 includes a transistor TW₁ and a transistor TW₂. Wherein, the drain terminal and the gate terminal of the NMOS-type transistor TW₁ are coupled to each other for receiving a corresponding data current I_{data}, while the source terminal thereof is coupled to the reference voltage V_{ref}. The drain terminal of the NMOS-type transistor TW₂ is coupled to the sub-pixel SP_{W} to generate a driving current I_{W} to drive the sub-pixel SP_{W}. Besides, the gate terminal and the source terminal of the transistor TW₂ are coupled to the gate terminal and the source terminal of the transistor TW₁, respectively. Wherein, the quotient of the ratio between the channel width and channel length of the transistor TW₂ by the ratio between the channel width and channel length of the transistor TW₁, (W_{W2}/L_{W2})/(W_{W1}/L_{W1}), is the fourth ratio. In the same way, the fourth ratio is used for adjusting the luminance of the sub-pixel SP_{W}.

Although in the above-described embodiments, the driving devices of the present invention are disposed in the display panel, the present invention does not limit thereto. Anyone skilled in the art is able to dispose the driving device outside the display panel to meet the requirement in practice, for example, as shown in FIG. 7, where the driving device is moved into the driving circuit of the display.

FIG. 7 is a diagram of an OLED display structure according to the fourth embodiment of the present invention. Referring to FIG. 7, an OLED display 700 provided by the present embodiment includes an OLED panel 710 and a driving circuit 730. Different from the above-described three embodiments, the driving device 733 herein is disposed in the driving circuit 730, which includes a data current generator 731 and a driving device 733. Wherein, the driving device 733 has a current mirror CM1, a current mirror CM2 and a current mirror CM3, and the current mirror CM1 includes an NMOS-type transistor TR₁ and an NMOS-type transistor TR₂. In the same way, the current mirror CM2 includes an NMOS-type transistor TG₁ and an NMOS-type transistor TG₂; the current mirror CM3 includes an NMOS-type transistor TB₁ and an NMOS-type transistor TB₂. The wiring structure and the operation principle thereof are similar to the above-described embodiments.

Similarly, every display pixel 711 of the OLED panel 710 includes sub-pixels SP_{R}, SP_{G} and SP_{B}. The current mirrors CM1, CM2 and CM3 would generate driving currents I_{R}, I_{G} and I_{B} to drive the sub-pixels SP_{R}, SP_{G} and SP_{B} on the OLED panel 710 according to the data currents I_{data} output from the data current generator 731.

The relationships among the luminance L_{R}, L_{G} and L_{B} of the sub-pixels SP_{R}, SP_{G} and SP_{B}, the driving currents I_{R}, I_{G}, I_{B}, the channel widths W_{R1}, W_{R2}, W_{B1}, W_{B2}, W_{G1} and W_{G2} and channel lengths L_{R1}, L_{R2}, L_{B1}, L_{B2}, L_{G1} and L_{G2} of the NMOS-type transistors TR₁, TR₂, TG₁, TG₂, TB₁ and TB₂ are similar to or the same as equations (10), (11) and (12).

Note that although the above-mentioned transistors TR₁, TR₂, TG₁, TG₂, TB₁ and TB₂ are NMOS-type transistors, however, anyone skilled in the art is also able to replace the NMOS-type transistors with PMOS-type transistors to meet the requirement in practice, which is without departing from the scope or spirit of the invention.

In summary, since the OLED panel of the present invention employs a driving device having a plurality of current mirrors, hence, it is able to adjust the luminance ratios among the different color sub-pixels by controlling the ratios between the channel width and channel length of the transistors in every current mirror without changing the rest devices and components of the OLED panel. In this way, the required luminance ratios of the OLED panel are obtained.

It will be apparent to those skilled in the art that various-modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An organic light-emitting diode panel (OLED panel), comprising:
a plurality of display pixels, wherein each of the display pixels comprises a plurality of sub-pixels corresponding to different color lights; and
a driving device, comprising a plurality of current mirrors for respectively receiving one of a plurality of data currents and respectively generating a driving current sent to the corresponding sub-pixels, wherein each of the current mirrors comprises a plurality of transistors,
wherein the current mirrors generate a plurality of different driving currents to drive the corresponding sub-pixels according to the ratios between the channel width and channel length of the transistors.

2. The OLED panel as recited in claim 1, wherein the transistors are PMOS-type transistors.

3. The OLED panel as recited in claim 1, wherein the transistors are NMOS-type transistors.

4. The OLED panel as recited in claim 1, wherein the driving device comprises a first current mirror, a second current mirror and a third current mirror for respectively driving the red sub-pixels, the green sub-pixels and the blue sub-pixels.

5. The OLED panel as recited in claim 4, wherein the first current mirror comprises:
a first transistor, wherein the first source/drain terminal and gate terminal thereof are coupled to each other for receiving the corresponding data current, while the second source/drain thereof is coupled to a reference voltage; and
a second transistor, wherein the first source/drain terminal is coupled to the corresponding sub-pixels for generating the corresponding driving current, while the gate terminal and second source/drain terminal thereof are coupled to the gate terminal and second source/drain terminal of the first transistor, respectively,
wherein the quotient of the ratio between the channel width and channel length of the second transistor by the ratio between the channel width and channel length of the first transistor is a first ratio.

6. The OLED panel as recited in claim 4, wherein the second current mirror comprises:
a third transistor, wherein the first source/drain terminal and gate terminal thereof are coupled to each other for receiving the corresponding data current, while the second source/drain thereof is coupled to a reference voltage; and
a fourth transistor, wherein the first source/drain terminal is coupled to the corresponding sub-pixels for generating the corresponding driving current, while the gate terminal and second source/drain terminal thereof are coupled to the gate terminal and second source/drain terminal of the third transistor, respectively,
wherein the quotient of the ratio between the channel width and channel length of the fourth transistor by the ratio between the channel width and channel length of the third transistor is a second ratio.

7. The OLED panel as recited in claim 4, wherein the third current mirror comprises:
a fifth transistor, wherein the first source/drain terminal and gate terminal thereof are coupled to each other for receiving the corresponding data current, while the second source/drain thereof is coupled to a reference voltage; and
a sixth transistor, wherein the first source/drain terminal is coupled to the corresponding sub-pixels for generating the corresponding driving current, while the gate terminal and second source/drain terminal thereof are coupled to the gate terminal and second source/drain terminal of the fifth transistor, respectively,
wherein the quotient of the ratio between the channel width and channel length of the sixth transistor by the ratio between the channel width and channel length of the fifth transistor is a third ratio.

8. The OLED panel as recited in claim 4, wherein the driving device further comprises a fourth current mirror for driving the white sub-pixels, and the fourth current mirror comprises:
a seventh transistor, wherein the first source/drain terminal and gate terminal thereof are coupled to each other for receiving the corresponding data current, while the second source/drain thereof is coupled to a reference voltage; and
an eighth transistor, wherein the first source/drain terminal is coupled to the corresponding sub-pixels for generating the corresponding driving current, while the gate terminal and second source/drain terminal thereof are coupled to the gate terminal and second source/drain terminal of the seventh transistor, respectively,
wherein the quotient of the ratio between the channel width and channel length of the eighth transistor by the ratio between the channel width and channel length of the seventh transistor is a fourth ratio.

9. A driving device, for receiving a plurality of data currents and generating a plurality of driving currents, suitable for driving a plurality of display pixels of an OLED panel, wherein each of the display pixels comprises a plurality of sub-pixels corresponding to different color lights, respectively; the driving device comprising:
a plurality of current mirrors, wherein each of the current mirrors comprises a plurality of transistors,
wherein the current mirrors correspondingly receive one of the data currents, respectively, and generate a plurality of driving currents to drive the corresponding sub-pixels according to the ratios between the channel widths and channel lengths of the transistors.

10. The driving device as recited in claim 9, wherein the transistors are PMOS-type transistors.

11. The driving device as recited in claim 9, wherein the transistors are NMOS-type transistors.

12. The driving device as recited in claim 9, wherein the driving device comprises a first current mirror, a second current mirror and a third current mirror for respectively driving the red sub-pixels, the green sub-pixels and the blue sub-pixels.

13. The driving device as recited in claim 12, wherein the first current mirror comprises:
a first transistor, wherein the first source/drain terminal and gate terminal thereof are coupled to each other for receiving the corresponding data current, while the second source/drain thereof is coupled to a reference voltage; and
a second transistor, wherein the first source/drain terminal is coupled to the corresponding sub-pixels for generating the corresponding driving current, while the gate terminal and second source/drain terminal thereof are coupled to the gate terminal and second source/drain terminal of the first transistor, respectively,
wherein the quotient of the ratio between the channel width and channel length of the second transistor by the ratio between the channel width and channel length of the first transistor is a first ratio.

14. The driving device as recited in claim 12, wherein the second current mirror comprises:
a third transistor, wherein the first source/drain terminal and gate terminal thereof are coupled to each other for receiving the corresponding data current, while the second source/drain thereof is coupled to a reference voltage; and
a fourth transistor, wherein the first source/drain terminal is coupled to the corresponding sub-pixels for generating the corresponding driving current, while the gate terminal and second source/drain terminal thereof are coupled to the gate terminal and second source/drain terminal of the third transistor, respectively,
wherein the quotient of the ratio between the channel width and channel length of the fourth transistor by the ratio between the channel width and channel length of the third transistor is a second ratio.

15. The driving device as recited in claim 12, wherein the third current mirror comprises:
a fifth transistor, wherein the first source/drain terminal and gate terminal thereof are coupled to each other for receiving the corresponding data current, while the second source/drain thereof is coupled to a reference voltage; and
a sixth transistor, wherein the first source/drain terminal is coupled to the corresponding sub-pixels for generating the corresponding driving current, while the gate terminal and second source/drain terminal thereof are coupled to the gate terminal and second source/drain terminal of the fifth transistor, respectively,
wherein the quotient of the ratio between the channel width and channel length of the sixth transistor by the ratio between the channel width and channel length of the fifth transistor is a third ratio.

16. The driving device as recited in claim 12, wherein the driving device further comprises a fourth current mirror for driving the white sub-pixels, and the fourth current mirror comprises:
a seventh transistor, wherein the first source/drain terminal and gate terminal thereof are coupled to each other for receiving the corresponding data current, while the second source/drain thereof is coupled to a reference voltage; and
an eighth transistor, wherein the first source/drain terminal is coupled to the corresponding sub-pixels for generating the corresponding driving current, while the gate terminal and second source/drain terminal thereof are coupled to the gate terminal and second source/drain terminal of the seventh transistor, respectively,
wherein the quotient of the ratio between the channel width and channel length of the eighth transistor by the ratio between the channel width and channel length of the seventh transistor is a fourth ratio.

17. An OLED display, comprising:
a driving circuit for outputting a plurality of data currents; and
an OLED panel, comprising:
a plurality of display pixels, wherein each of the display pixels comprises a plurality of sub-pixels corresponding to different color lights; and
a driving device, comprising a plurality of current mirrors for respectively receiving one of the data currents and respectively generating a driving current sent to the corresponding sub-pixels, wherein each of the current mirrors comprises a plurality of transistors,
wherein the current mirrors correspondingly receive one of the data currents, respectively, and generate a plurality of different driving currents to drive the corresponding sub-pixels according to the ratios between the channel widths and channel lengths of the transistors.

18. The OLED display as recited in claim 17, wherein the transistors are PMOS-type transistors.

19. The OLED display as recited in claim 17, wherein the transistors are NMOS-type transistors.

20. The OLED display as recited in claim 17, wherein the driving device comprises a first current mirror, a second current mirror and a third current mirror for respectively driving the red sub-pixels, the green sub-pixels and the blue sub-pixels.

21. The OLED display as recited in claim 20, wherein the first current mirror comprises:
a first transistor, wherein the first source/drain terminal and gate terminal thereof are coupled to each other for receiving the corresponding data current, while the second source/drain thereof is coupled to a reference voltage; and
a second transistor, wherein the first source/drain terminal is coupled to the corresponding sub-pixels for generating the corresponding driving current, while the gate terminal and second source/drain terminal thereof are coupled to the gate terminal and second source/drain terminal of the first transistor, respectively,
wherein the quotient of the ratio between the channel width and channel length of the second transistor by the ratio between the channel width and channel length of the first transistor is a first ratio.

22. The OLED display as recited in claim 20, wherein the second current mirror comprises:
a third transistor, wherein the first source/drain terminal and gate terminal thereof are coupled to each other for receiving the corresponding data current, while the second source/drain thereof is coupled to a reference voltage; and
a fourth transistor, wherein the first source/drain terminal is coupled to the corresponding sub-pixels for generating the corresponding driving current, while the gate terminal and second source/drain terminal thereof are coupled to the gate terminal and second source/drain terminal of the third transistor, respectively,
wherein the quotient of the ratio between the channel width and channel length of the fourth transistor by the ratio between the channel width and channel length of the third transistor is a second ratio.

23. The OLED display as recited in claim 20, wherein the third current mirror comprises:
a fifth transistor, wherein the first source/drain terminal and gate terminal thereof are coupled to each other for receiving the corresponding data current, while the second source/drain thereof is coupled to a reference voltage; and
a sixth transistor, wherein the first source/drain terminal is coupled to the corresponding sub-pixels for generating the corresponding driving current, while the gate terminal and second source/drain terminal thereof are coupled to the gate terminal and second source/drain terminal of the fifth transistor, respectively,
wherein the quotient of the ratio between the channel width and channel length of the sixth transistor by the ratio between the channel width and channel length of the fifth transistor is a third ratio.

24. The OLED display as recited in claim 20, wherein the driving device further comprises a fourth current mirror for driving the white sub-pixels, and the fourth current mirror comprises:
a seventh transistor, wherein the first source/drain terminal and gate terminal thereof are coupled to each other for receiving the corresponding data current, while the second source/drain thereof is coupled to a reference voltage; and
an eighth transistor, wherein the first source/drain terminal is coupled to the corresponding sub-pixels for generating the corresponding driving current, while the gate terminal and second source/drain terminal thereof are coupled to the gate terminal and second source/drain terminal of the seventh transistor, respectively,
wherein the quotient of the ratio between the channel width and channel length of the eighth transistor by the ratio between the channel width and channel length of the seventh transistor is a fourth ratio.
